(19) United States
(12) Patent Application Publication
(10) Pub. No.: US 2014/0230912 A1
(43) Pub. Date: Aug. 21, 2014

(54) DEVICE FOR HANDLING OBJECTS, USING ACOUSTIC FORCE FIELDS

(71) Applicants: Jean-Luc Aider, Vanves (FR); Olivier Dron, Bures Sur Yvette (FR); Mauricio Hoyos, Creteil (FR)

(72) Inventors: Jean-Luc Aider, Vanves (FR); Olivier Dron, Bures Sur Yvette (FR); Mauricio Hoyos, Creteil (FR)

(73) Assignee: CENTRE NATIONAL DE LA RECHERCHE SCIENTIFIQUE, Paris Cedex 16 (FR)

(21) Appl. No.: 14/241,585

(22) PCT Filed: Jul. 30, 2012
(86) PCT No.: PCT/IB2012/053882

§ 371 Date: May 13, 2014

(30) Foreign Application Priority Data
Aug. 30, 2011 (FR) 11 57658

(51) Int. Cl. F15D 1/00

(52) U.S. Cl. CPC F15D 1/00
USPC 137/13; 137/803

(57) ABSTRACT

The invention relates to a device (1) intended for handling objects (O) present in a channel (2) within a fluid (F), in particular a liquid. The device comprises: a channel (2) extending along a longitudinal axis (X), said channel (2) having a transverse section with a width (_) measured along a first transverse axis (Y) and a thickness measured along a second transverse axis (Z) perpendicular to the first, said width (_) being greater than or equal to the thickness, and said channel comprising first (3) and second (4) walls along the second transverse axis (Z); and an acoustic wave generator (10) generating acoustic waves in the channel from at least one of the walls (3; 4), said acoustic wave generator (10) operating at a frequency f that is different from a resonant frequency f₀ of the channel (2) along the second transverse axis (Z).

The present invention relates to devices for handling objects by means of an acoustic force field within a channel, notably a microchannel.

### PRIOR ART

Acoustophoresis can be used to handle and sort particles by means of an acoustic force. In the conventional technique, known in the prior art, at least one acoustic pressure node is created at a given position along a dimension (length, width or thickness) of a channel by providing a resonance condition for the acoustic wave.

The present invention provides freedom from the constraint regarding the position of the pressure node imposed by the resonance condition.

WO 2006/095117 describes a fluid separation device in which an acoustic force field can be generated.

WO 98/17373 and WO 02/072234 describe methods of separating particles by the application of an acoustic force field leading to the formation of a standing wave within a channel.

The paper by Dron et al., “Parametric study of acoustic focusing of particles in a micro-channel in the perspective to improve micro-PIV measurements” (Microfluid Nano-fluid (2009) 7: 857-867) describes the usefulness of acoustic focusing by the formation of a standing wave in a channel in order to improve micro-PIV measurement.

WO 2009/071733 describes the focusing of particles over the width of a microchannel by the use of an acoustic transducer operating at frequencies corresponding to resonance frequencies of said microchannel.

WO 2006/032703 describes a method for separating particles by modification (“switching”) of the applied frequency from one resonance frequency of a channel to another.

The paper by Glynne-Jones et al., “Mode-switching: A new technique for electronically varying the agglomeration position in an acoustic particle manipulator” (Ultrasonics 50 (2010) 68-75) describes the possibility of displacing the acoustic focusing height over part of the height of a channel by rapidly modifying the operating frequency from one resonance frequency of said channel to another.

The paper by Svennebring et al., “Selective Bioparticle Retention and Characterization in a Chip-Integrated Confocal Ultrasonic Cavity” (J. Biotech. Bioeng, 103, 323-328 (2009)) describes the possibility of handling cells by operating at a resonance frequency of a cavity.

The paper by Petersson et al., “Separation of lipids from blood utilizing ultrasonic standing waves in microfluidic channels” (Analyst, 2004, 129, 938-943) describes the separation of lipids from blood by the formation of an acoustic standing wave.

The paper by Lipkens et al., “The Effect of Frequency Sweeping and Fluid Flow on Particle Trajectories in Ultrasonic Standing Waves” (IEEE Sensors Journal, Vol. 8, No. 6, June 2008, 667-677) describes a simulation of the effect produced by a variation of the operating frequency of a transducer generating an acoustic force field along the length of a macrochannel.

Numerous methods of acoustophoresis known at the present time are seriously limited by the position of the pressure nodes, which is dictated by the resonance condition.

If a negative acoustic impedance contrast factor (such as a bubble, lipid or liposome) is present, the particles will migrate toward the pressure antinodes.

There is also a known document, WO 2004/030800, which describes the use of a device for promoting mixing phenomena in a channel, but does not provide any description of a phenomenon resembling acoustic focusing.

Furthermore, the known methods may not be capable of satisfactorily focusing a large number of objects, notably layers of objects, within a channel.

Consequently there is a need for a device capable of focusing objects over the whole of a dimension of a channel, and not only in discrete positions corresponding to the pressure nodes or antinodes produced when it is operated at a resonance frequency of the channel.

There is a need to provide a device capable of focusing large numbers of objects, and notably layers of objects, within a channel.

There is a need to provide a device which allows the focusing position of objects to be varied as a function of a characteristic and/or of the position of the objects within a channel.

There is also a need to provide a device allowing improved measurement of the norm and/or direction and/or sense of the velocity vector of objects present within a channel.

The present invention is intended to meet some or all of the aforesaid needs.

### SUMMARY

In a first of its aspects, the invention relates to a device intended for the handling of objects present in a channel within a fluid, notably a liquid, including:
a channel extending along a longitudinal axis, the channel having a cross section with a width measured along a first transverse axis and a thickness measured along a second transverse axis perpendicular to the first, the width being greater than or equal to the thickness, the channel having first and second walls along the second transverse axis,
an acoustic wave generator which generates acoustic waves from at least one of said walls,
   said acoustic wave generator operating at a frequency f which is different from a resonance frequency f₀ of the channel along the second transverse axis.

The term “longitudinal axis of the channel” signifies the line joining the set of centers of gravity of the cross sections of the channel. The longitudinal axis of the channel may be straight or curved and may be contained in a plane which may be a plane of symmetry for some or all of the cross sections of the channel.

The thickness e of the channel is equal to the distance, measured along the second transverse axis, separating the first and second walls.

The expression “f₀ being a resonance frequency of the channel along the second transverse axis” signifies that f₀ is such that the thickness e of the channel, measured at a given position along the longitudinal axis of the channel, is determined by

$$\underline{e} = \frac{n λ}{2} ,$$

where n is an integer and

$$λ = \frac{{c}_{f}}{{f}_{0}}$$

where c_{f} denotes the speed of sound in the fluid present within the channel, at the temperature of the fluid, for example 20° C. In other words, the frequency f₀ is equal to the theoretical frequency which, at a given position along the longitudinal axis of the channel, meets the condition of resonance of the acoustic wave in the channel and gives rise to the formation of a standing wave along its second transverse axis, in other words along its thickness.

The inventors have experimentally demonstrated the possibility of varying the acoustic focusing position over a large part of the thickness of the channel. This effect was achieved by generating an acoustic wave in the thickness of said channel and varying the operating frequency of the acoustic wave generator between different frequencies, each different from a resonance frequency of said channel along its second transverse axis.

Without wishing to be bound by any explanation or theory, the inventors consider that, by generating an acoustic force field over the thickness, rather than over the width as in WO 2009/071733, it may be possible to limit the effect of acoustic streaming.

Consequently the present invention offers freedom from the limitation to discrete locations for the focusing positions, and thus constitutes a major innovation in the field of handling objects within a channel by means of an acoustic force field.

Advantageously, at least one layer of objects is formed by acoustic focusing.

Also advantageously, at least one extremum of acoustic pressure is formed within the fluid by the generated acoustic waves.

The layer of objects is preferably focused at an extremum of acoustic pressure (an acoustic node or antinode) is formed within the fluid by the generated acoustic waves. For example, a plurality of layers of distinct objects is formed, each of these layers being present at a distinct acoustic pressure extremum.

The layer of objects that is formed may have a shape which is elongated along the longitudinal axis of the channel, and may be, for example, oval or rectangular in shape when viewed in a direction perpendicular to the plane of flattening of the layer. In a variant, the layer of objects that is formed may have a circular or square shape when viewed in a direction perpendicular to its plane of flattening.

Acoustic Wave Generator

The acoustic wave generator may, for example, operate at a frequency equal to or less than 10 MHz, and notably in the range from 0.5 to 10 MHz.

By using the acoustic wave generator in these frequency ranges, it may advantageously be possible to handle living cells without damaging them.

The acoustic wave generator preferably operates at a frequency f which is different from f₀ and is in the range from 0.75f₀ to 1.25f₀, notably from 0.75f₀ to 0.95f₀ or from 1.05f₀ to 1.25f₀.

By using the acoustic wave generator in these frequency ranges, close to a resonance frequency, it may advantageously be possible to create a sufficiently large acoustic force to provide satisfactory focusing of the particles.

The acoustic wave generator is preferably a wide-band acoustic wave generator.

A plurality of acoustic wave generators may be arranged along the channel and may generate acoustic waves from at least one of the first and second walls, said acoustic wave generators possibly being positioned, notably, on the same side of the channel.

The use of a plurality of acoustic wave generators is advantageous when the fluid flows at high velocity or when layers of large particles are to be generated. In the first case, the flight time under the generators decreases as the fluid velocity increases. This may require a greater number of transducers to be used in order to achieve focusing. In the second case, in the absence of flow for example, it is possible to use a plurality of acoustic wave generators to form layers of large particles.

When a plurality of acoustic wave generators are used, at least one of them may generate an acoustic wave along the first transverse axis of the channel, that is to say along the width of the channel.

In the latter case, the width/thickness ratio may be in the range from 1 to 10, notably from 1 to 3.

By applying an acoustic force field over the thickness and over the width, it may advantageously be possible to move a set of particles, for example a line of particles, in any area of the channel, and thus to benefit from a larger number of available locations for the acoustic focusing.

The acoustic wave generator may be supplied with a sinusoidal voltage. In a variant, the acoustic wave generator may be supplied with a triangular or square-wave voltage.

The acoustic wave generator may be operated by digital or analog control.

The acoustic wave generator may, for example, be fixed to the first and second wall or walls of the channel. This fixing may be carried out by any way known to persons skilled in the art, notably by gluing.

A layer of acoustic matching material may be present between the acoustic wave generator and at least one of the first and second walls of the channel.

The acoustic matching may be provided by using any material known to persons skilled in the art as suitable for this purpose.

Channel

The thickness of the channel may be constant or variable with respect to movement along the longitudinal axis of the channel, with, for example, at least two areas located in axial sequence and having different thicknesses.

The channel may, for example, have a thickness of less than 3 cm, or preferably less than 1 cm, over at least a portion of its length, notably over the whole of its length. The channel is, for example, a microchannel.

The term “microchannel” signifies a channel having a thickness equal to or less than 1 mm over the whole of its length.

The channel may have a thickness in the range from 50 μm to 1 mm, preferably from 100 μm to 500 μm, over at least a portion of its length, notably over the whole of its length.

The width of the channel may be constant or variable with respect to movement along the longitudinal axis of the channel, with, for example, at least two areas located in axial sequence and having different widths.

The channel may have a width in the range from 1 mm to 30 mm, preferably from 5 mm to 20 mm, over at least a portion of its length, notably over the whole of its length.

The channel may have a substantially constant cross section with respect to movement along its longitudinal axis.

The channel may have a rectangular cross section over at least a portion of its length, notably over the whole of its length.

In a variant, the channel may have a square or circular cross section over at least a portion of its length, notably over the whole of its length.

The length of the channel, measured along the longitudinal axis, may, for example, be in the range from 3 mm to 10 cm, preferably from 10 mm to 70 mm.

The channel may advantageously have a length/thickness ratio greater than or equal to 10, for example greater than or equal to 12.

At least one of the first and second walls, preferably both, may include, or notably consist of, a material chosen from among the following: mineral or organic glasses, quartz, thermoplastic materials, notably PMMA or polycarbonate, and metals. More generally, any material having a high acoustic impedance, that is to say an acoustic impedance at least ten times greater than that of the fluid, may be used.

The wall facing the wall from which the acoustic waves are generated may include, or notably consist of, a material having an acoustic impedance at least ten times greater than that of the fluid.

By using materials having a high acoustic impedance in the walls, it is advantageously possible to improve the acoustic focusing of objects by promoting the formation of a prominent pressure extremum.

In an exemplary embodiment, at least one of the first and second walls, preferably both, may include, or notably consist of, a mineral or organic glass or PMMA.

The device may, for example, be such that the acoustic wave generator generates acoustic waves from the first wall of the channel, which may be an upper wall, and:
the first and second walls include, or notably consist of, PMMA, or
the first and second walls include, or notably consist of, a mineral or organic glass, or
the first wall includes, or notably consists of, PMMA, and the second wall includes, or notably consists of, a mineral or organic glass.

The first and/or second walls may, for example, be in the form of plates.

The first and/or second walls may have a thickness in the range from 0.5 mm to 5 mm over at least a portion of their length, notably over the whole of their length.

At least one of the first and second walls, for example both walls, may be opaque.

In a variant, at least one of the first and second walls, for example both walls, may be transparent. The use of transparent walls may be preferred if it is desirable to acquire images of objects present within the channel, as detailed below.

The wall or walls opposite the wall or walls from which the acoustic waves are generated may oscillate freely when the device is in operation.

The channel may include a plurality of outlets, toward which the objects are selectively guided according to the frequency f at which the acoustic wave generator operates.

The size or sizes of the outlet or outlets toward which the objects are selectively guided may be adapted to the size of said objects.

Fluids and Objects

The fluid may be a biological liquid such as blood.

In a variant, the fluid may be water.

The fluid may, for example, be transparent to visible radiation.

The fluid may be at rest when the device is in operation. In a variant, the fluid may be in a state of flow, for example in a state of laminar flow, when the device is in operation.

The objects may be, for example, monodisperse or polydisperse biological cells, notably blood cells, for example globules. In the latter case, the method according to the invention may be used, for example, in procedures for sorting said biological cells.

The objects may be rigid or deformable particles, for example particles of polystyrene.

The mean size of the objects present within the channel may, for example, be less than or equal to 50 μm. The term “mean size” denotes the statistical particle size at half the population, called D50.

The frequency f at which the acoustic wave generator operates may be such that its associated wavelength is greater than the mean size of the objects present within the channel, preferably greater than or equal to ten times this mean size.

The thickness of the channel may, at least at a position along the longitudinal axis at which the acoustic waves are generated, be greater than or equal to ten times the mean size of the objects present within the channel.

Sensor and Control System

The invention may, in an exemplary embodiment, relate to an assembly including a device as defined above, with which the following are associated:
a sensor which can be used to measure at least one characteristic and/or the position of the objects present in the channel, said sensor generating a signal as a result of this measurement, and
a control system receiving said signal and controlling the frequency f at which the acoustic wave generator operates and/or the amplitude of the acoustic waves generated as a function of said signal.

The sensor may also be used to measure at least one characteristic of the fluid, notably its flow velocity and/or its flow rate and/or its temperature, said sensor generating a signal as a function of the result of this measurement, and the control system receiving said signal and controlling the frequency f at which the acoustic wave generator operates and/or the amplitude of the acoustic waves generated as a function of said signal.

If the fluid present in the channel is in a state of flow, the sensor may, for example, be placed upstream of at least one acoustic wave generator relative to the direction of the flow.

In a variant, the sensor may be placed downstream of at least one acoustic wave generator relative to the direction of the flow.

The sensor may, for example, be used to measure the size of the objects. In this case, the sensor may include:
a light source, notably a laser, intended to illuminate the objects located in a given area of the channel, and
a control system including, notably consisting of, a light radiation detector, intended to detect the radiation emitted from said light source and diffused by said objects, and adapted to produce a signal which is a function of the size of the objects which have diffused the light radiation.

According to another exemplary embodiment, the concentration of the objects within a given area of the channel can be measured by the sensor.

The sensor may be, for example, a Coulter counter or a UV detector.

The control system may include a computer.

The control system may control a power supply stage of the acoustic wave generator, for example a signal generator, connected to an amplifier stage.

Acquisition and Processing of Images of the Objects Present within the Channel

The invention may, in an exemplary embodiment, relate to an assembly including:
a device as defined above,
an illumination system configured to illuminate at least some of the objects present within the channel, and
an image acquisition system configured to acquire at least one image of at least some of the objects that are present within the channel and that are illuminated by the illumination system,
   said assembly including, notably, a device for processing the at least one image produced by the acquisition system.

The illumination system may be configured to illuminate some or all of a layer of objects formed by acoustic focusing.

The processing device may be used to measure the norm and/or direction and/or sense of the velocity vector of at least some of the objects that are present within the channel and that are illuminated by the illumination system.

The assembly according to the invention may, notably, be used to execute a method of particle image velocimetry (PIV).

The device for processing the at least one image may, for example, include a computer.

The image processing device may, for example, be configured to calculate a correlation coefficient of the distributions of luminous intensity found in at least two images of objects produced by the image acquisition system.

The inventors have found that the use of the acoustic focusing devices and methods described in the present invention enables measurements made by particle image velocimetry to be improved, notably by allowing the acoustic focusing of the objects within the channel at a precise position over the whole thickness of the channel.

Independently, or in combination with the foregoing, the present invention, in another of its aspects, relates to a device intended for the handling of objects present in a channel within a fluid, notably a liquid, including:
a channel extending along a longitudinal axis, the channel having a cross section with a width measured along a first transverse axis and a thickness measured along a second transverse axis perpendicular to the first, the width being greater than or equal to the thickness, the channel having first and second walls along the second transverse axis, and
a wide-band acoustic wave generator which generates acoustic waves from at least one of the first and second walls.

Methods

Independently, or in combination with the foregoing, the present invention, in another of its aspects, relates to a method for handling objects present in a channel with the aid of an acoustic wave generator, using, notably, a device or an assembly as defined above, wherein:
said channel extends along a longitudinal axis and has a cross section with a width measured along a first transverse axis and a thickness measured along a second transverse axis perpendicular to the first, the width being greater than or equal to the thickness, the channel having first and second walls along the second transverse axis, and
said acoustic wave generator generates acoustic waves from at least one of the first and second walls, and operates at a frequency f which is different from a resonance frequency f₀ of the channel along the second transverse axis.

The method described above may be used in at least one of the following applications: methods of sorting species, for example rigid or deformable particles, polydisperse particles, biological cells, notably blood cells, for example cancer cells present in a specimen of blood or globules, bacteria, colloidal or non-colloidal emulsions, proteins or liposomes; methods of diagnosis or analysis; methods of purification, enrichment or depletion of species; methods of synthesis of species; methods of modification of physical or chemical characteristics of species; methods of medicinal product research; methods of mixing or methods of measuring diffusion coefficients.

The method according to the invention may, in particular, be used for the purposes of separating particles initially included in a mixture of polydisperse particles.

The size differences between polydisperse particles may enable the particles to be separated according to the differences in their migration velocity toward the acoustic pressure node generated along the thickness of the channel.

The method according to the invention may enable at least one layer of objects to be formed by acoustic focusing. In particular, the method according to the invention may include a step in which at least two chemical species present in the layer formed by acoustic focusing are made to react.

The method according to the invention may also allow the coalescence of a plurality of layers of objects, or the fusion of films.

The method according to the invention may also enable filterless filtration to be carried out by selective acoustic focusing of the handled objects.

Independently, or in combination with the foregoing, the invention, in another of its aspects, relates to a method for handling objects present in a channel with the aid of an acoustic wave generator, using, notably, a device as defined above, wherein:
said channel extends along a longitudinal axis and has a cross section with a width measured along a first transverse axis and a thickness measured along a second transverse axis perpendicular to the first, the width being greater than or equal to the thickness, the channel having first and second walls along the second transverse axis,
said acoustic wave generator generates acoustic waves from at least one of the first and second walls, and operates at a frequency f,
at least one characteristic and/or the position of the objects present in the channel is measured by a sensor,
said sensor generates a signal as a function of the result of said measurement,
said signal is sent toward a control system which is used to control the frequency at which the acoustic wave generator operates and/or the amplitude of the acoustic waves generated as a function of said signal, and
the frequency f at which the acoustic wave generator operates is modified as a function of said signal.

The method according to the invention may include a step of moving the objects along the thickness of the channel after the modification, as a function of the signal generated by the control system, of the frequency f at which the acoustic wave generator operates.

The method according to the invention may thus advantageously enable the position of the objects to be modified in real time, for example according to the size or nature of the objects.

Thus, a method according to the invention for separating polydisperse particles may, for example, be executed by modifying the frequency at which the acoustic wave generator operates and by making use of the fact that particles of different sizes have different relaxation velocities toward the nodes.

Said movement of the objects may take place between a first position, different from an acoustic focusing position of said objects, and a second position, different from the first, which is an acoustic focusing position of said objects. This movement may, notably, take place if the measurement made by the sensor is performed before the objects have been subjected to the acoustic waves generated.

In a variant, the movement of the objects, as a result of the modification of the frequency f at which the acoustic wave generator operates, may take place between a first acoustic focusing position of said objects and a second acoustic focusing position of said objects, said second position being different from the first.

When the fluid is in a state of flow, the modification of the position of the objects may enable said objects to be guided selectively toward a given outlet of the channel.

In other words, the method according to the invention may enable the positions of the objects to be modified at least as a function of the result of a measurement of a characteristic and/or of the positions of the objects within the channel.

The step of movement of the objects as a result of the modification of the frequency f at which the acoustic wave generator operates may, for example, allow the concentration at a given position of objects which, notably, have substantially the same size.

This concentration step may, notably, be used as part of a method for sorting species, notably for sorting polydisperse particles.

This concentration step may also be followed by at least one chemical reaction, said chemical reaction possibly being used, notably, to quantify the content of the objects and/or to determine their nature.

The chemical reaction may, for example, take place between at least two compounds which have been concentrated in the same position during the concentration step.

The chemical reaction may take place within the channel, notably in the acoustic force field.

In a variant, the chemical reaction may not take place within the channel. In this case, the objects concentrated by the method according to the invention may be selectively guided toward an outlet of the channel, for example in order to be collected in an enclosure. The chemical reaction may then take place in said enclosure. In a variant, the enclosure containing the objects concentrated by the method according to the invention may be transported toward an attached device containing a reagent intended to quantify the content of said objects and/or to determine their nature.

As mentioned above, the sensor may be placed downstream of at least one acoustic wave generator relative to the direction of the flow.

In this case, the method according to the invention may comprise the following steps:
varying the frequency at which the acoustic wave generator operates among a plurality of frequencies,
using the sensor to measure at least one characteristic and/or the position of the objects for each of said frequencies,
comparing the values obtained for the measurements made at each of said frequencies with at least one reference value,
selecting a frequency among said plurality of frequencies for which the comparison of the values obtained with the reference value gives a predetermined result,
causing the acoustic wave generator to operate at this selected frequency.

It is possible, for example, to measure the density of the objects downstream of the acoustic wave generator relative to the direction of flow, and to select the frequency at which the maximum density is obtained.

The method according to the invention may thus advantageously include a step of learning an optimal operating frequency and of controlling the acoustic wave generator to make the latter operate at this optimal frequency.

This learning stage can be repeated several times in the method according to the invention or, in a variant, may be used only once or not at all.

Independently, or in combination with the foregoing, the invention relates to a method for acquiring at least one image of objects present within a channel, including the following steps:

a) handling the objects by using a method as described above, in order to obtain acoustic focusing of said objects in a given area of the channel,

b) illuminating the objects in the acoustic focusing area by means of an illumination system, and

c) acquiring, by means of an acquisition system, at least one image of said objects illuminated in this way.

The method may, for example, include a step of acquiring at least a first image of the objects, in a first instant, and a second image of the objects, in a second instant.

The method may also include a step of calculating a correlation coefficient of the distributions of luminous intensity found in these first and second images.

The method may, in particular, be a method for measuring the norm and/or direction and/or sense of the velocity vector of objects that are present within the channel and that are illuminated by the illumination system.

This method may, for example, use a step of calculating one of the aforesaid quantities on the basis of the first and second images defined above.

The method may, for example, be a method of particle image velocimetry.

### DESCRIPTION OF THE DRAWINGS

The invention will be more clearly understood from the following detailed description of non-limiting examples of embodiments thereof, and from the attached drawing, in which:

FIG. 1 shows, in a schematic and partial manner, an example of an experimental device for characterizing a wide-band acoustic wave generator,

FIG. 2 shows, in a schematic and partial manner, an example of a signal obtained for a wide-band acoustic wave generator,

FIG. 3 shows, in a schematic and partial manner, an example of a device according to the invention,

FIG. 4 shows, in a schematic and partial manner, a section taken along IV-IV through the device of FIG. 3,

FIGS. 5 to 7 show, in a schematic and partial manner, variant embodiments of the invention,

FIG. 8 shows the effect of the frequency of the acoustic wave on the focusing height of the objects in a microchannel, and

FIGS. 9 to 13 show the effect of various parameters on the acoustic focusing.

### PROTOCOL FOR THE CHARACTERIZATION OF A WIDE-BAND ACOUSTIC WAVE GENERATOR

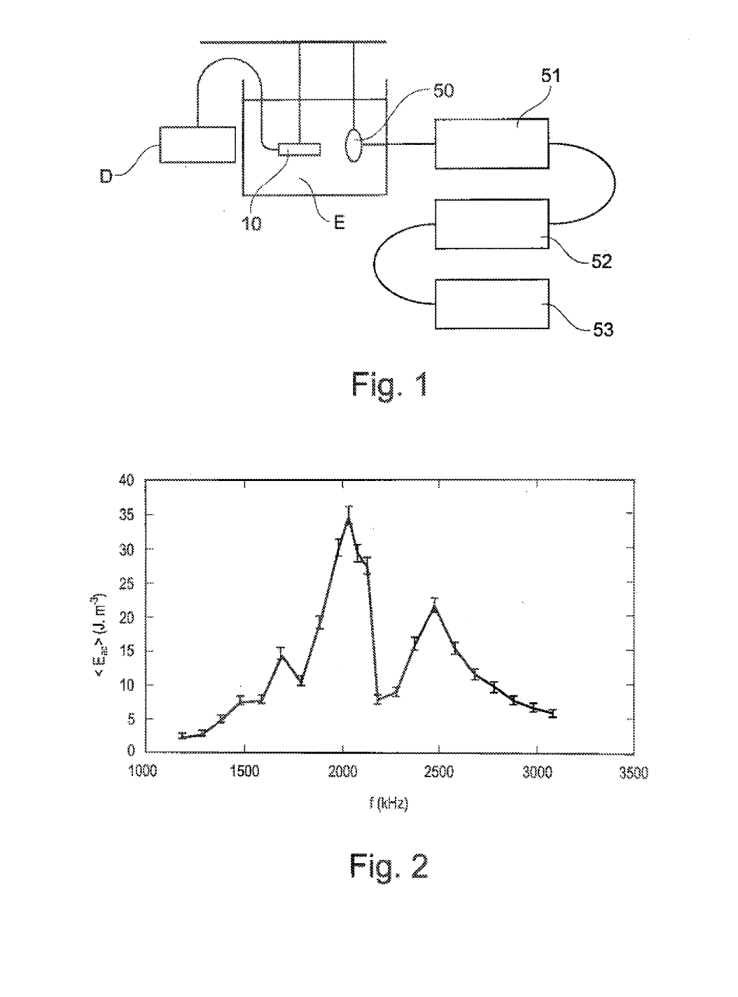

The experimental device detailed below and shown in FIG. 1 can be used to determine whether an acoustic wave generator can be considered to be a wide-band generator.

As shown in FIG. 1, an acoustic wave generator 10, operating at a given operating frequency, is placed in a tank filled with water E and supplied with a sinusoidal voltage by a power supply device D. The supply voltage is 10 V. A membrane 50 of polyethylene terephthalate (Mylar®) is placed facing the acoustic wave generator 10, the membrane 50 being perpendicular to the axis of the acoustic wave generator 10. The membrane 50 is chosen, notably with regard to its thickness and its spacing in relation to the acoustic wave generator, in such a way that the movement of the membrane corresponds to the movement of the fluid particles due to the generation of the acoustic wave. In other words, the membrane 50 creates a negligible resistance to the fluid particle flow created by the acoustic wave that is produced.

The beam of a laser (not shown) is directed toward the membrane 50 and is reflected by the latter. The beam reflected by the membrane 50 is then directed toward a photodetector 51, which transmits a signal proportional to the luminous intensity received. The signal obtained at the output of the photodetector 51 is then demodulated by a demodulator 52 to produce a voltage which is a linear function of the movement of the membrane 50.

This voltage is then differentiated numerically with respect to time, using a sampling frequency of 5 GHz, by means of a device 53 provided for this purpose. The numerical differentiation may, for example, be performed by a numerical simulation software package such as Matlab®.

The profile of the velocity of movement of the membrane as a function of time is then obtained, and the maximum value of this profile of the velocity of movement of the membrane vo is determined and averaged over 10 measurements to obtain v′o. From this, the mean value of the acoustic enemy <E_{ac> is then deduced, this value being given by the formula:}

$$〈 {E}_{ a c} 〉 = \frac{{ρ}_{F} v {o}^{′ 2}}{2}$$

where ρ_{F} denotes the density of the fluid.

In order to determine whether the acoustic wave generator is a wide-band generator, the effect of the variation of the operating frequency of the acoustic wave generator on the value <E_{ac}> is quantified. The protocol described above is repeated with variations in the operating frequency of the acoustic wave generator. The value of <E_{ac}> found for the different frequency values is then reported. The maximum value of acoustic energy <E_{ac}>ₘₐₓ will be found at the nominal operating frequency of the acoustic wave generator.

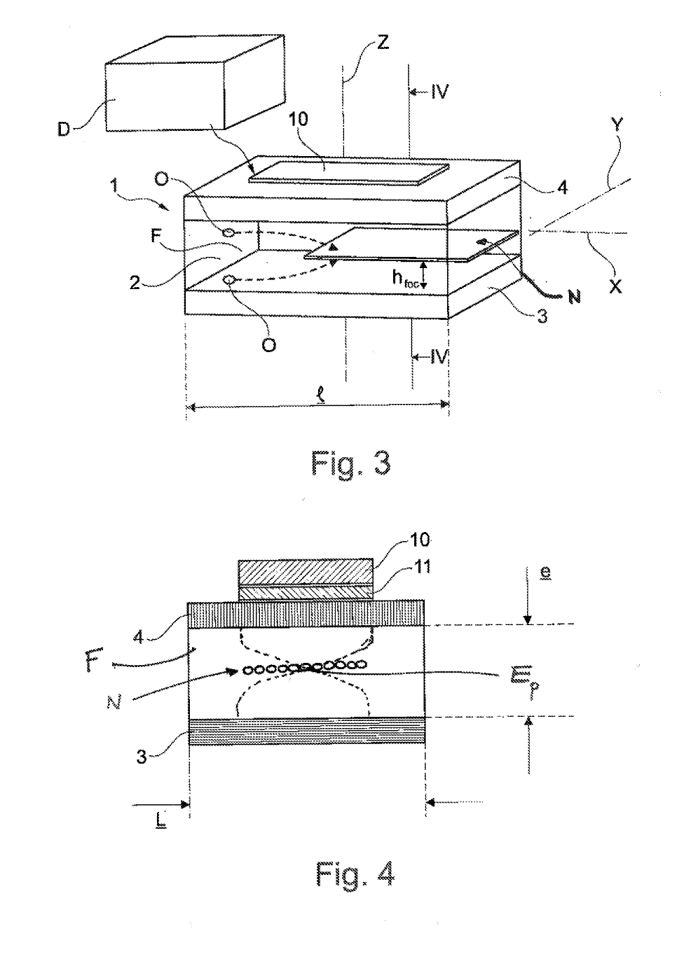

The acoustic wave generator is considered to be a wide-band generator if the ratio <E_{ac}>/<E_{ac}>ₘₐₓ is found to be greater than or equal to 15%, preferably greater than or equal to 40%, over a frequency range of [0.75*nominal frequency of the acoustic wave generator; 1.25*nominal frequency of the acoustic wave generator]. FIG. 2 shows the trend of <E_{ac}> as a function of the frequency for a wide-band acoustic wave generator, determined in the operating conditions detailed above.

In this example, the polyethylene terephthalate membrane has a thickness of 12 μm and is located at a distance of 1 mm from the acoustic wave generator.

In the example of FIG. 2, the acoustic wave generator used is a transducer marketed by the Signal Processing® corporation, with a cylindrical geometry, having a length of 30 mm, a diameter of 7 mm, and a nominal operating frequency of about 2 MHz.

Examples of Devices Used in the Context of the Present Invention

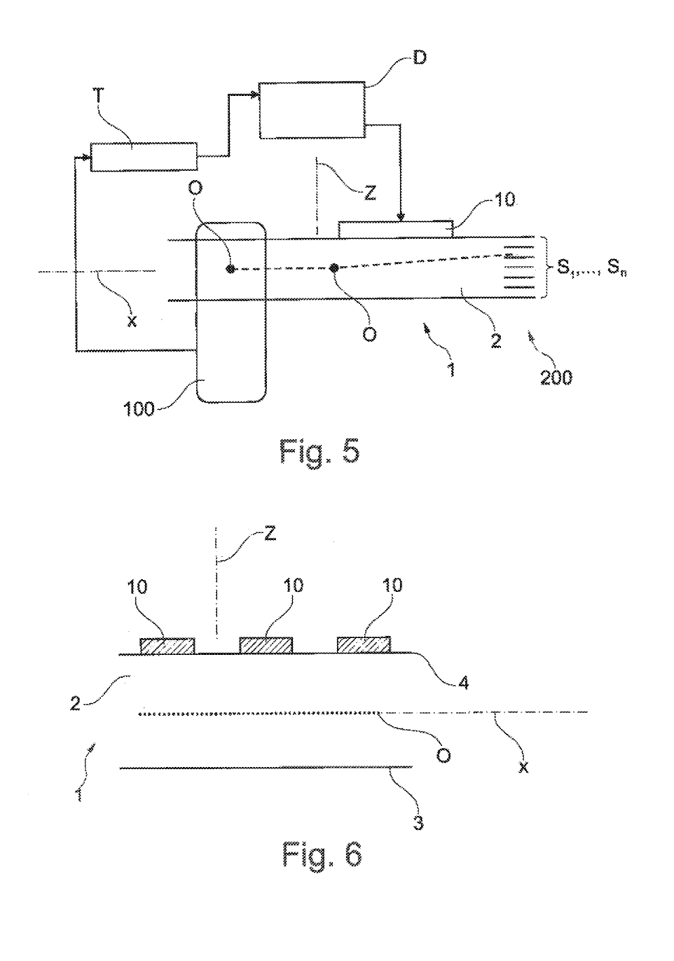

FIG. 3 shows a device 1 according to the invention. This device has a lower wall 3 and an upper wall 4 delimiting a channel 2 in which a fluid F is contained. The fluid F may be in a state of flow, for example in a state of laminar flow, or, in a variant, may be at rest.

The fluid F includes a plurality of objects O which may be monodisperse or polydisperse. The objects O may, in particular, be biological cells, in which case the fluid F may be a biological liquid such as blood.

An acoustic transducer 10 can be fixed to the upper wall 4 of the device 1, as shown. The transducer 10 is a wide-band transducer.

In a variant, the transducer 10 may not be a wide-band transducer, provided that it can be used to generate acoustic waves at a frequency f which is different from a resonance frequency fₒ of the channel 2 along the second transverse axis Z.

The transducer marketed by the Signal Processing® corporation, with a cylindrical geometry, having a length of 30 mm, a diameter of 7 mm, and a nominal operating frequency of about 2 MHz, may, for example, be used in the device 1 according to the invention.

It is possible to use a transducer 10 having a geometry other than cylindrical, notably a parallelepipedal geometry as shown in FIG. 3.

The transducer 10 is supplied with a signal obtained from a generator D, which may, for example, include or notably consist of a signal generator connected in series with a voltage amplifier stage. The generator D preferably supplies the transducer 10 with a sinusoidal signal having a given frequency. In a variant, the supply voltage may be triangular or square-wave.

In operation, the transducer 10 can provide an acoustic force field along the transverse axis Z of the channel, along the thickness of the latter, thus enabling objects O to be focused at a focusing height h_{foc}. As mentioned above, the focusing height h_{foc} is a function of the operating frequency of the transducer 10.

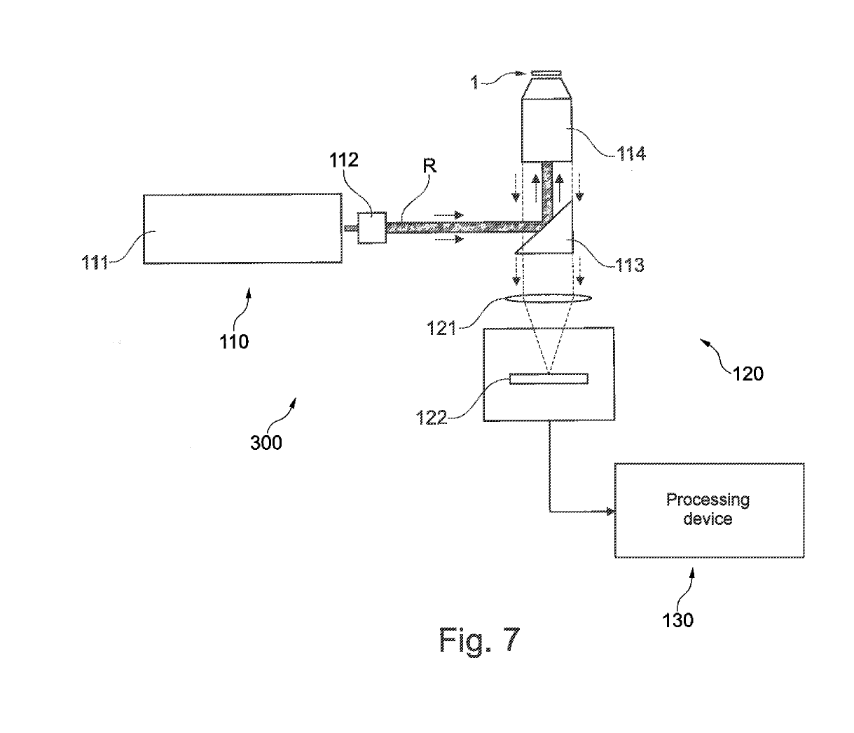

FIG. 3 shows how a layer N of objects O can be produced at the focusing height h_{foc}. This layer N can be formed at a pressure extremum Eₚ (node or antinode) generated by the transducer 10 (see FIG. 4).

In the example shown in FIG. 3, the wall 3 includes a material having a high acoustic impedance, that is to say an impedance at least ten times greater than that of the fluid F. Thus it is possible to have a wall 3, facing the wall 4 from which the acoustic waves are generated, which includes a material having a high acoustic impedance. Two walls are said to be “facing” when they are located along the axis of application of the acoustic waves generated by the transducer 10 operating at a frequency f other than f₀.

In a variant embodiment, each of the walls 3 and 4 includes, or notably consists of, a material having a high acoustic impedance.

As shown in FIG. 4, a layer of gel 11 for acoustic impedance matching may be present between the transducer 10 and the upper wall 4.

FIG. 4 also shows the formation of a pressure extremum Eₚ within the fluid F by the acoustic waves generated by the transducer 10. In the illustrated example, the layer N of objects O is focused at the level of the pressure extremum Eₚ.

In the illustrated example, the layer N of objects O is focused at the level of the pressure extremum Eₚ. In a variant which is not illustrated, the layer N is focused at the level of a pressure antinode. In a variant which is not illustrated, the generated acoustic waves form a plurality of acoustic pressure extrema, and two different layers are each focused at the level of a different pressure extremum. It is therefore possible to obtain a first layer focused at the level of a first pressure extremum and a second layer focused at the level of a second pressure extremum, different from the first.

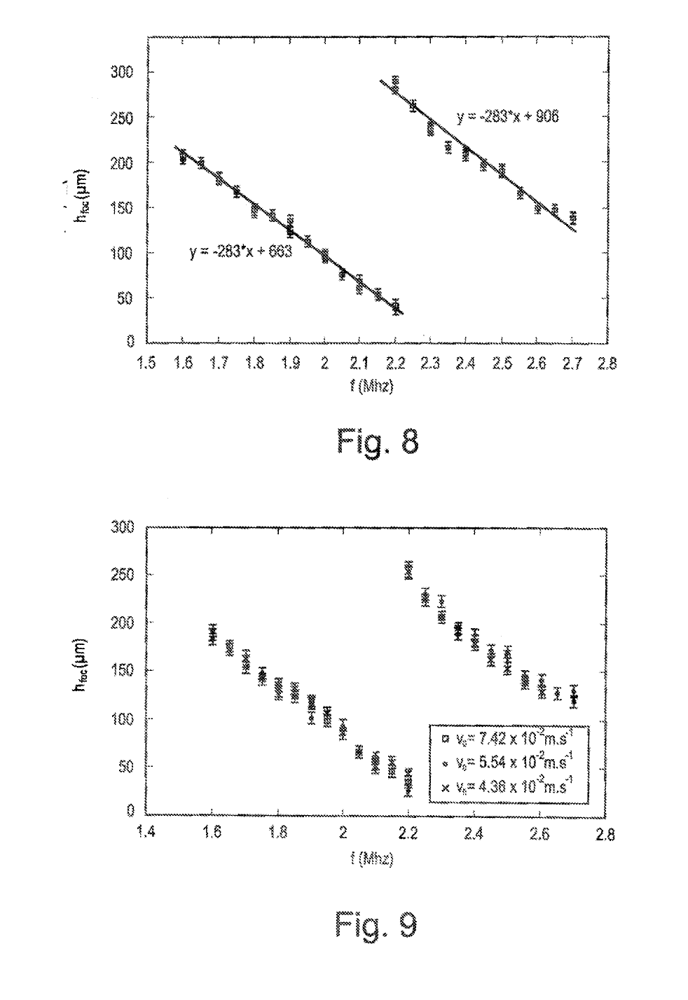

FIG. 5 shows an exemplary embodiment of an assembly 200 including a device 1 according to the invention and a sensor 100 for measuring at least one characteristic and/or the position of the objects present in the channel 2. The sensor 100 generates a signal as a function of the result of this measurement, this signal being sent toward a control system T. The control system T can be used to act on the generator D, in accordance with the signal received from the sensor 100, to control the frequency at which the transducer 10 operates and/or the amplitude of the acoustic waves generated.

The sensor 100 may, for example, be used to measure the density and/or the size of the objects O.

The signal generated by the sensor 100 may cause the transducer 10 to be controlled in such a way that the objects O are guided selectively to at least one of the outlets (S₁, . . . , Sₙ).

The sensor 100 may, for example, be used to measure the size of the objects O and may include, for this purpose, a laser and a detector measuring the luminous intensity diffused by the objects O present in the channel 2.

In a variant, the sensor 100 may include, or notably consist of, a Coulter counter, for counting the objects O and determining their size, or a UV detector.

In one exemplary embodiment, it is possible to form layers of particles or cells or even biological membranes, and guide them toward one of the outlets (S₁, . . . , Sₙ).

FIG. 6 shows an exemplary embodiment of a device 1 including a plurality of transducers 10. In this example, the transducers 10 are arranged along the channel 2 on the same side.

It is also possible, within the scope of the present invention, for the transducers 10 to be arranged on both sides of the channel 2.

FIG. 7 shows an exemplary embodiment of an assembly 300 according to the invention for acquiring an image of objects O present in the channel 2. The assembly 300 includes a device 1 associated with an illumination system 110 and with an image acquisition system 120.

The illumination system 110 includes a light source 111 which may, for example, include a laser, notably an Nd:YAG laser. In one embodiment, the light source 111 includes a combination of two pulsed Nd:YAG lasers, and the objects O are fluorescent particles, the Nd:YAG lasers emitting a radiation with a wavelength of 532 nm, intended to be absorbed by the objects O.

An optical structure 112 can be placed at the output of the light source 111 in order to match the radiation emerging from the latter to the optical device.

The radiation R produced at the output of the structure 112 can be guided toward a reflective structure 113 so as to be focused toward a lens 114.

The separator 113 may, for example, include a combination of a filter and a dichroic mirror. The lens 114 may, for example, be a microscope lens having its focal plane located substantially at the level of the acoustic focusing area.

The reflective structure 113 may be chosen, notably, so as not to filter the radiation with the wavelength capable of being absorbed by the objects O present in the channel 2, for example if the objects O are fluorescent.

For example, if the objects O are fluorescent, the radiation R may be absorbed, and the objects O may emit a radiation having a different wavelength, for example a longer wavelength.

The reflective structure 113 may be configured so that it substantially allows the passage of only the radiation re-emitted by the objects O and guided toward the lens 121.

As regards the image acquisition device 120, this has a lens 121 for focusing the radiation from the objects O present in the channel 2 on a sensor 122, enabling an image of said objects O to be produced. The sensor 122 may, for example, be a CCD camera.

The sensor 122 may, for example, be connected to an image processing device 130, which may include a computer.

The processing device 130 may be used to measure the norm and/or direction and/or sense of the velocity vector of at least some of the objects O that are present in the channel 2 and that are illuminated by the illumination system 110.

If at least two images of the objects O are captured, the processing device 130 may be used to calculate a correlation coefficient of the distributions of luminous intensity found in these at least two images of objects O.

### EXAMPLES

### Example 1

The channel used is a microchannel with a thickness of 337 μm, a width of 10 mm and a length of 40 mm. The microchannel is filled with water. The upper and lower walls of the microchannel are both made in the form of 1 mm thick plates of PMMA. The objects are polystyrene particles with a diameter of 7 μm, in a concentration of 56 mg/L.

This type of channel has two resonance peaks around 2 MHz and 2.5 MHz.

The acoustic wave generator used is a cylindrical transducer marketed by the Signal Processing® corporation, having a diameter of 7 mm, a height of 30 mm, and a nominal operating frequency of about 2 MHz. The acoustic wave generator is fixed at the position of the upper wall of the microchannel. The transducer supply voltage is 10 V.

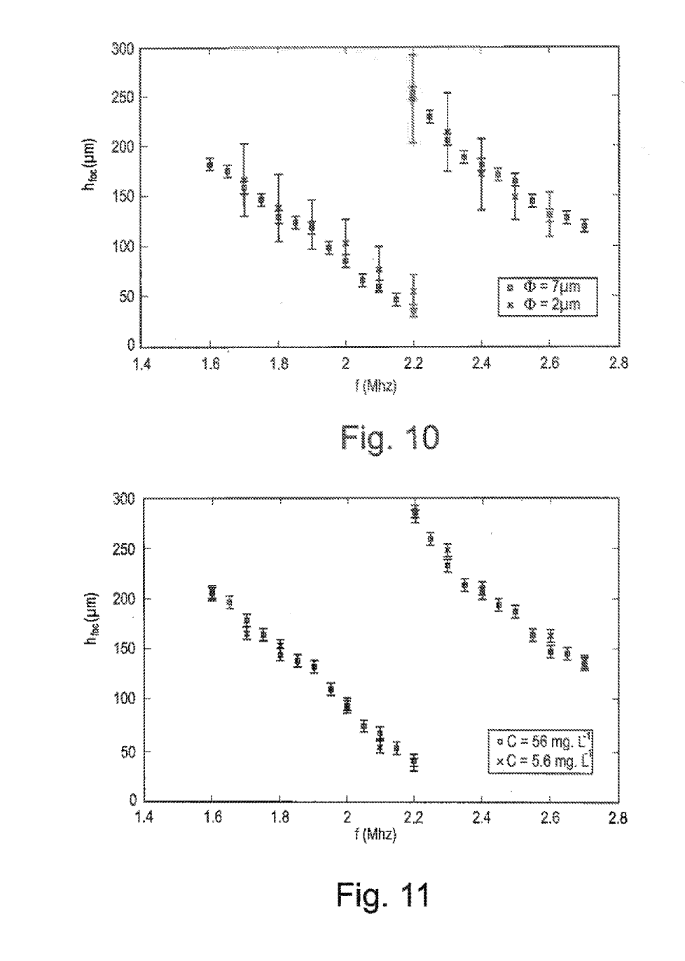

FIG. 8 shows the effect of the operating frequency of the transducer on the focusing height of the particles h_{foc}. The curves found with or without a step of rehomogenization of the particles in the microchannel between the application of two different frequencies are superimposed on this figure.

### Example 2

### Effect of the Acoustic Energy

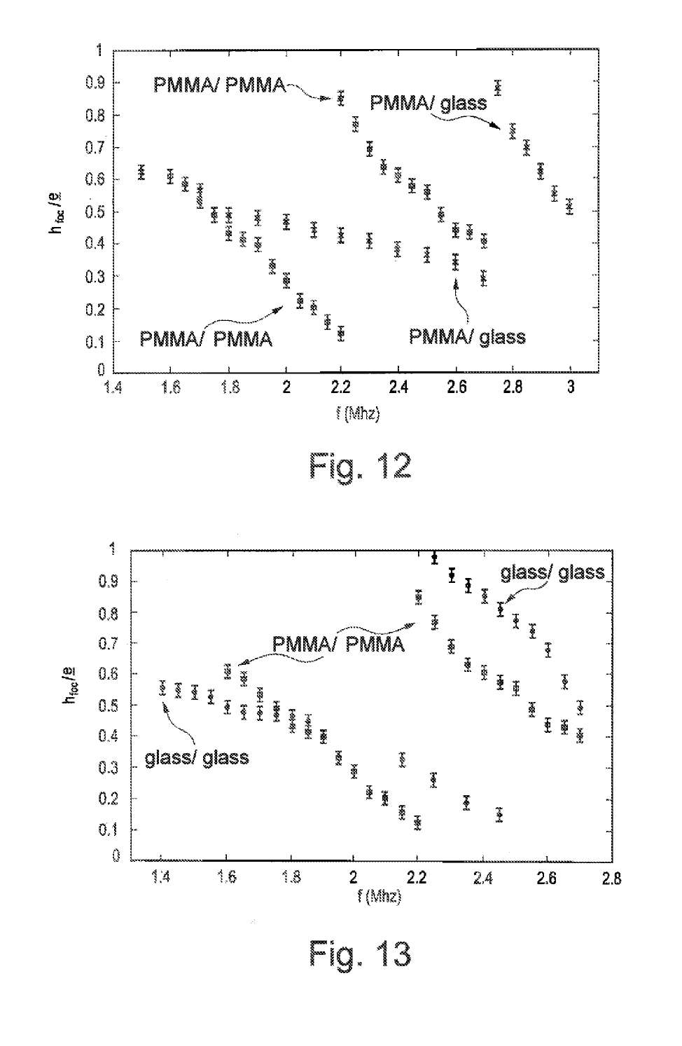

The operating conditions detailed in Example 1 were repeated, with the exception of the transducer supply voltage, the effect of which was examined. Three experiments were conducted, at transducer supply voltages of 5 V, 7 V and 10 V respectively. The maximum values of the velocity profile of the fluid particles resulting from the generation of the acoustic wave are shown in FIG. 9. The results are shown in FIG. 9. It appears that the amplitude of the acoustic wave, controlled by the transducer supply voltage, has no effect on the phenomenon under consideration, namely the displacement of the focusing height of the particles.

### Example 3

### Effect of the Size of the Objects

The operating conditions detailed in Example 1 were repeated, with the exception of the diameter of the particles, the effect of which was examined. Two experiments were conducted, using particles with diameters of 2 μm and 7 μm respectively. The results are shown in FIG. 10. It appears that the diameter of the particles used has no effect on the phenomenon under consideration, namely the displacement of the focusing height of the particles.

### Example 4

### Effect of the Concentration of the Objects

The operating conditions detailed in Example 1 were repeated, with the exception of the concentration of objects, the effect of which was examined. Two experiments were conducted, using particles at concentrations of 5.6 mg/L and 56 mg/L respectively. The results are shown in FIG. 11. It appears that the concentration of particles used has no effect on the phenomenon under consideration, namely the displacement of the focusing height of the particles.

### Example 5

### Effect of the Material Forming the Walls

The operating conditions detailed in Example 1 were repeated, with the exception of the nature of the materials forming the upper and lower walls, the effect of which was examined. Additionally, the thickness of the microchannel was adapted to the nature of the materials used to form the walls. The results are shown in FIGS. 12 and 13.

The annotation “PMMA/PMMA” indicates a channel having upper and lower walls made of PMMA. The annotation “PMMA/glass” indicates a channel having an upper wall of PMMA and a lower wall of glass. The annotation “glass/glass” indicates a channel having upper and lower walls made of glass.

The expression “including a” is to be interpreted as meaning “including at least a”.

Unless specified otherwise, the expression “in the range from” is to be interpreted as inclusive of the limits.

1-27. (canceled)

28. A device intended for the handling of objects present in a channel within a fluid, notably a liquid, including:
a channel extending along a longitudinal axis, the channel having a cross section with a width measured along a first transverse axis and a thickness measured along a second transverse axis perpendicular to the first, the width being greater than or equal to the thickness, the channel having first and second walls along the second transverse axis,
an acoustic wave generator which generates acoustic waves in the channel from at least one of said walls,
said acoustic wave generator operating at a frequency f which is different from a resonance frequency f₀ of the channel along the second transverse axis, and at least one layer of objects being formed by acoustic focusing.

29. The device as claimed in claim 28, the channel having a thickness of less than 3 cm, notably less than 1 cm, over at least a portion of its length.

30. The device as claimed in claim 28, the channel having a substantially rectangular cross section over at least a portion of its length.

31. The device as claimed in claim 28, including a plurality of acoustic wave generators arranged along the channel and generating acoustic waves from at least one of the walls.

32. The device as claimed in claim 28, at least one of the walls including a material chosen from among the following: mineral or organic glasses, thermoplastic materials, notably PMMA or polycarbonate, quartz, and metals in which the product (density of the metal x velocity of sound in this metal) is greater than or equal to 10⁶ Pa·s/m.

33. The device as claimed in claim 28, at least one of the walls including a material having an acoustic impedance at least ten times greater than that of the fluid.

34. The device as claimed in claim 33, the wall facing the wall from which the acoustic waves are generated by the acoustic wave generator including a material having an acoustic impedance at least ten times greater than that of the fluid.

35. The device as claimed in claim 28, at least one extremum of acoustic pressure being formed within the fluid by the generated acoustic waves.

36. The device as claimed in claim 35, the layer of objects being focused at the level of the acoustic pressure extremum.

37. The device as claimed in claim 28, the acoustic wave generator operating at a frequency f equal to or less than 10 MHz.

38. The device as claimed in claim 28, the acoustic wave generator operating at a frequency f which is different from f₀ and is in the range from 0.75f₀ to 1.25f₀.

39. The device as claimed in claim 28, the channel including a plurality of outlets, toward which the objects are selectively guided according to the frequency fat which the acoustic wave generator operates.

40. The device as claimed in claim 28, the channel having a length measured along its longitudinal axis such that the length/thickness ratio is greater than or equal to 10.

41. An assembly including:
a device as claimed in claim 28,
a sensor which can be used to measure at least one characteristic and/or the position of the objects present in the channel, said sensor generating a signal as a result of this measurement, and
a control system receiving said signal and controlling the frequency fat which the acoustic wave generator operates and/or the amplitude of the acoustic waves generated as a function of said signal.

42. An assembly including:
a device according to claim 28,
an illumination system configured to illuminate at least some of the objects present in the channel, and
an image acquisition system configured to acquire at least one image of at least some of the objects that are present in the channel and that are illuminated by the illumination system said assembly including, notably, a device.

43. The assembly as claimed in claim 42, the processing device making it possible to measure the norm and/or direction and/or sense of the velocity vector of at least some of the objects that are present in the channel and that are illuminated by the illumination system.

44. The assembly as claimed in claim 43, the illumination system being configured to illuminate all or part of the layer of objects produced by acoustic focusing.

45. A method for handling objects present in a channel by means of an acoustic wave generator, using a device as claimed in claim 28 or an assembly as claimed in claim 44, in which method:
said channel extends along a longitudinal axis and has a cross section with a width measured along a first transverse axis and a thickness measured along a second transverse axis perpendicular to the first, the width being greater than or equal to the thickness, the channel having first and second walls along the second transverse axis, and
said acoustic wave generator generates acoustic waves in the channel from at least one of the walls and operates at a frequency f which is different from a resonance frequency f₀ of the channel along the second transverse axis.

46. The method as claimed in claim 45, the frequency f being different from f₀ and being in the range from 0.75f₀ to 1.25f₀.

47. The method as claimed in claim 46, wherein:
at least one characteristic and/or the position of the objects present in the channel is measured by a sensor,
a signal is generated as a function of the result of the measurement made by said sensor and is sent toward a control system, and
the frequency fat which the acoustic wave generator operates and/or the amplitude of the acoustic waves generated is modified as a function of said signal by the action of the control system.

48. A method for acquiring at least one image of objects present within a channel, including the following steps:
a) handling the objects by using a method as claimed in claim 47 in order to obtain acoustic focusing of said objects in a given area of the channel,
b) illuminating the objects in the acoustic focusing area by means of an illumination system, and
c) acquiring, by means of an acquisition system, at least one image of said objects illuminated in this way.

49. A method for measuring the norm and/or direction and/or sense of the velocity vector of objects that are present in a channel, including the following steps:
acquiring a first image of the objects in a first instant, by using the method as claimed in claim 48,
acquiring a second image of the objects in a second instant, by using the method as claimed in claim 48, and
calculating from the first and second images a measurement of the norm and/or direction and/or sense of the velocity vector of objects.

50. The method as claimed in claim 49, characterized in that it is used in at least one of the following applications: particle image velocimetry (PIV), methods of sorting species, methods of diagnosis or analysis; methods of purification, enrichment or depletion of species; methods of synthesis of species; methods of modification of physical or chemical characteristics of species; methods of medicinal product research; methods of mixing or methods of measuring diffusion coefficients.

51. The method as claimed in claim 50, the objects being monodisperse or polydisperse biological cells.

52. A device intended for the handling of objects present in a channel within a fluid including:
a channel extending along a longitudinal axis, the channel having a cross section with a width measured along a first transverse axis and a thickness measured along a second transverse axis perpendicular to the first, the width being greater than or equal to the thickness, the channel having first and second walls along the second transverse axis,
an acoustic wave generator which generates acoustic waves in the channel from at least one of said walls,
said acoustic wave generator operating at a frequency f which is different from a resonance frequency f₀ of the channel along the second transverse axis,
the first and second walls including a material having an acoustic impedance at least ten times greater than that of the fluid.

53. A device intended for the handling of objects present in a channel within a fluid including:
a channel extending along a longitudinal axis, the channel having a cross section with a width measured along a first transverse axis and a thickness measured along a second transverse axis perpendicular to the first, the width being greater than or equal to the thickness, the channel having first and second walls along the second transverse axis,
an acoustic wave generator which generates acoustic waves in the channel from at least one of said walls, said acoustic wave generator operating at a frequency f which is different from a resonance frequency f₀ of the channel along the second transverse axis, and is in the range from 0.75f₀ to 1.25f₀.

54. The device as claimed in claim 53, additionally having any of the characteristics mentioned in claim 29.
